(19) United States
(12) Patent Application Publication
(10) Pub. No.: US 2009/0174542 A1
(43) Pub. Date: Jul. 9, 2009

(54) SYSTEM AND METHOD FOR INCREASING SIGNAGE AWARENESS AND VISIBILITY

(76) Inventors: Sharon Gentry, Federal Way, WA (US); Jordyn Wintersole, Federal Way, WA (US); Alyssa Wolf, Federal Way, WA (US); Sara Yazdi, Auburn, WA (US); Hannah Zeitler, Kent, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/348,703

(22) Filed: Jan. 5, 2009

Related U.S. Application Data
(60) Provisional application No. 61/018,832, filed on Jan. 3, 2008.

(51) Int. Cl. G08B 23/00; F21V 21/00; H05B 37/02; F21S 19/00

(52) U.S. Cl. 340/500; 362/249.02; 315/313; 116/202

(57) ABSTRACT

A system for increasing awareness and enhancing visibility of a sign that includes a base attached to the sign panel, a plurality of illumination devices coupled to the base, a power source, and a controller coupled to the illumination devices and the power source.

### BACKGROUND

1. Technical Field

The present disclosure pertains to visibility of signage and, more particularly, to a modular system and method for adapting existing signage and constructing new signage that increases signage awareness, provides notification of dangerous situations and conditions, and facilitates evacuations.

2. Description of the Related Art

Existing signs are developed to provide governance, to regulate the flow of traffic, and to provide warnings and direction. In many situations these goals are not met because signs are difficult to see due to obstructions, inadequate lighting, or simple lack of awareness. In dangerous situations, such as volcanic eruptions, hurricanes, or ice storms, it is essential for all necessary signage to be visible.

Various methods have been proposed to address the foregoing situations. For example, Tsao et al., U.S. Pat. No. 6,031,468, describes a warning light attachment adapted for use with a stop sign. The warning light attachment includes a main unit, a holder for attaching the main unit to one edge of the stop sign, a solar cell for providing electrical energy, an energy storage device, a light emitting element in the main unit, and a charge control circuit coupled to the solar cell, energy storage device, and light emitting element. The charge control circuit selectively directs electrical energy from the solar cell to energy storage device or from the energy storage device to the light emitting element. Tsao et al. provides no suggestion of remote control, especially in emergency situations.

Mumford et al., U.S. Pat. No. 6,407,675, describes a traffic sign warning light system configured to slide and lock onto an edge of a sign to provide visual indication of the sign. The system houses one or more lights, which may be incandescent lamps or light emitting diodes. A controller, activated by a switch, controls the intensity, pattern, and color of the lights. The controller may incorporate a receiver to activate and control the lights in response to a transmitted signal from a remote transmitter. Mumford et al. fail to provide a base that has enhanced visibility without relying on electrical lighting.

Sloan et al., U.S. Pat. No. 7,213,941, is directed to an elongated flexible lighting system which includes an array of light sources in a translucent flexible material. The array of light sources may be light emitting diodes (LEDs), incandescent bulbs, or solid state lasers and is configured to give the appearance of a continuous light source. The elongated flexible system may be attached in the shape of a sign. A controller manipulates the color and intensity of the array of light sources. Sloan et al. do not suggest the need for remote control during emergency situations.

O'Brien, U.S. Pat. No. 4,484,104, illustrates a solar-powered sign lighting system which stores energy in batteries and provides a sensor to detect external light intensity. The solar cells are situated on the upper portion of the post supporting the sign. The lights are mounted inside the housing to back-light the advertising panel. The system provides a means for selectively illuminating the lights when visibility is below a predetermined level. Additionally, the system provides a means for illuminating the lights at a particular time for a particular length of time. However, O'Brien does not recognize the need for outside control in response to an evacuation situation.

Friedman et al., U.S. Pat. No. 4,929,936 describes an LED illuminated sign for displaying the number of a residence. The LEDs, which can change color, are arranged on panels, where each panel forms a seven-segment display. Each seven-segment display can form any number from 0-9. Actuation of the LEDs occurs via a manual switch, an ambient light photocell, or a simple radio receiver. The receiver may be adapted to receive a digital signal from a remote transmitter. A separate emergency switch is provided with the manual switch and the remote transmitter to change the color and activate a flasher in the event of an emergency. Friedman et al. merely alerts people to danger and provides no alerting of people away from danger.

Tapco, Traffic and Parking Control Co., Inc. (www.tapconet.com) offers traffic signs that integrate LEDs and the circuitry into the sign to increase visibility. The signs with LEDs are manufactured as one unit and are powered by solar panels and nickel metal hydride batteries. The LEDs are located along the outer edge of the signs, typically where two edges come together at a point. Tapco requires customers to purchase a new sign and provides no means to adapt an existing sign with LEDs.

There is currently no system that provides a base attachable to an existing or new sign and in which the base is adapted to bring awareness to the sign without the use of illuminating devices. In addition, existing designs do not enable remote activation of illumination devices or other electro-mechanical devices that draw attention to the sign in response to a dangerous condition or to provide direction for evacuation. Hence, there is a need for such a system to increase awareness of signage, especially in the event of low visibility conditions or a dangerous situation, to enable remote activation, and to provide a visible indication of necessary routing.

### BRIEF SUMMARY

The present disclosure pertains to increasing awareness and enhancing visibility of existing and new signage. In accordance with one aspect of the present disclosure, a modular kit to retrofit an existing sign is provided, the kit includes a base configured to be attached to the sign, a plurality of illumination devices attached to the base, a power source, and a controller coupled to the illumination devices and the power source. Preferably, the illumination devices include at least one light emitting diode. Ideally, a housing component is provided to protect the electronic elements from damage.

Ideally, the controller is structured to activate and deactivate the illumination devices after receipt of at least one from among a radio frequency communication, an output from a sensor, and manual activation of a switch. The controller is also structured to activate and deactivate the illumination devices in various patterns.

According to the present disclosure, a sign is provided that includes a support, a panel affixed to the support, a base affixed to the panel, a plurality of illumination devices attached to the base, a power source, and a controller coupled to the illumination devices and the power source. Ideally, the illumination devices include at least one light emitting diode and a housing component protects the illumination device, the power source, and the controller. The controller is structured to deactivate and activate the illumination devices after receipt of a signal to indicate a condition. The controller is also configured to output a plurality of patterns for activating and deactivating the illumination devices.

In accordance with another aspect of the present disclosure, a system for increasing awareness and enhancing visibility of signage provides a device to attach the system to existing or new signage, a power circuit structured to provide power to the system, a sensor configured to detect a condition, and a control circuit configured to activate the illumination devices to provide notification of the condition, including in one embodiment to communicate a visual alert or warning. The sensor is structured to receive a signal indicating a condition. The control circuit is structured to communicate a visual indication of the condition by activating and deactivating a plurality of illumination devices in response to an output from the sensor. Ideally, the system also provides a housing to protect the system from damage or tampering.

In accordance with another aspect of the present disclosure, an enhancement for signs includes a base adapted for attachment to an existing or new sign and a means for alerting associated with the base where the alerting means continuously provides a visual alert to the presence of the sign. The alerting means may be reflective material, iridescent pigment, fluorescent material, phosphorescent material, or photoluminescent material. Another embodiment utilizes an activation system that responds to the presence of ash or vapor, such as from a volcano, or that responds to movement of the earth of a predetermined magnitude, such as during a landslide or rock slide or earthquake. The alerting means may also include a passive mechanical means such as flags, spinners, or wind socks that are controlled remotely for deployment.

### BRIEF DESCRIPTION OF THE SEVERAL VIEWS OF THE DRAWINGS

The foregoing and other features and advantages of the present invention will be more readily appreciated as the same become better understood from the following detailed description when taken in conjunction with the accompanying drawings, wherein:

FIG. 1 is a front plan view of an embodiment of a system for enhancing signage visibility and providing guidance in an emergency;

FIG. 2 is a rear plan view of the system in FIG. 1;

FIG. 3 is a side plan view of the system in FIG. 1;

FIG. 4 illustrates kit components in accordance with an embodiment of the present invention;

FIG. 5 illustrates a block diagram of electrical components of the system in FIG. 1;

FIG. 6 illustrates a block diagram of electrical components of the kit of FIG. 4, according to another embodiment of the present disclosure; and

FIG. 7 illustrates a rear view of the base from the kit of FIG. 4 having a plurality of illumination devices attached.

### DETAILED DESCRIPTION

A plethora of signs provide information about regulations, guidance, and warnings. However, people are not always aware of the existence or of the meaning of each of these signs.

The present disclosure is directed to bringing awareness to or increasing awareness of signs and to enhance signage visibility, especially during emergency situations. In one embodiment of the present disclosure a kit is provided to retrofit an existing sign to increase visibility. Particularly, the kit increases the visibility of signs in low light conditions, emergency situations, poor weather conditions, and in circumstances where the sign is simply difficult to see. For example, a sign indicating an evacuation route is not necessary for everyday travel, however in the case of an evacuation the awareness of its existence and its visibility are essential. The kit retrofits evacuation signs and renders the signs highly visible to remind the public of their existence and to be perceivable in conditions of reduced visibility.

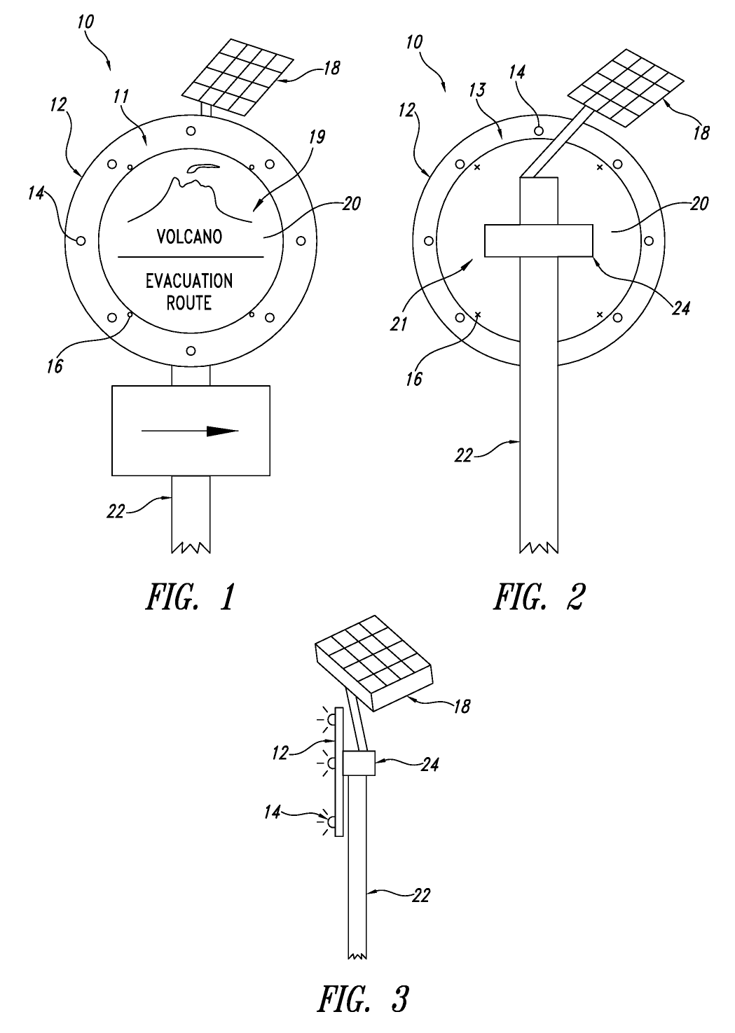

Referring initially to FIG. 1, shown therein is a system 10 to enhance visibility of signage in accordance with one embodiment of the present disclosure. The system 10 illustrates components of a retrofit kit installed on an existing sign panel 20 that is mounted on a support post 22.

In the illustrated embodiment, the system 10 includes a base 12, a plurality of illumination devices 14 attached to the base, a power source 18, and a control circuit 24 (as seen in FIG. 2). The base 12 has a front face 11 and a back face 13. The back face 13 of the base 12 overlaps a portion of the sign panel 20 and is attached to the sign panel 20 with permanent fasteners, in this case pop rivets 16. Other conventional fasteners, permanent or removable, may be used to attach the base 12 to the sign panel 20 including, but not limited to adhesives, clips, clamps, rivets, and pop rivets, red lok-tite or equivalent. A reversible clamp with a locking means may be used to provide for removal or repair of the system. The base 12 may be attached to the front or the back of the sign panel 20. Preferably, the fasteners secure the base to the sign in a manner to prevent tampering while still allowing for movement for repair or removal of the base 12 or associated components of the base 12.

The base 12 can be advantageously manufactured to conform to any size and shape of sign panel 20, i.e., circular, rectangular, triangular, oval, or hexagonal. The base 12 may be formed of any material that is sufficiently rigid to support the illumination devices 14 and to securely attach to the existing sign panel 20. The material of base 12 may be formed of the same material as the sign panel 20 or of a different material such as metal, plastic, composite, wood, or a combination of these.

In an alternate embodiment, the base 12 may be coupled to the post 22 instead of to the sign panel 20. Braces (not shown) may couple to the back face 13 of the base 12 and securely attach the base 12 to the post 22. The brace may be formed of any suitable material to adequately support the base 12, i.e., metal, firm plastic, or a composite material. Any suitable fastening means may be used to secure the brace to the post 22 and to the base 12. When installed, the front face 11 of the base 12 may be flush with a front side 19 of the sign panel 20, so that the sign panel 20 is encircled by the base 12. However, the base 12 may be arranged to extend past the front side 19 or a back side 21 of the sign panel 20. In addition, braces of various shapes may be used to attach the base 12 at an angle to increase visibility. For example, if the system 10 is located at the top of a steep hill, it may be advantageous to angle the base 12 at a downward angle so that the system 10 is more easily observed from a location at the bottom of the hill.

Independent of the illumination devices 14, the base 12 may possess features that bring awareness to the sign in a number of ways, such as reflective tape or paint, reflective components, a reflective polished surface, iridescent tape or paint, ridges, surface ornamentation, phosphorescence, flags, or some electromechanical means, such as moving flags. Another mechanical means of drawing attention to the sign panel 20 may include openings in the base 12 that contain reflective devices on fixed rods which allow for movement activated by wind, such as a reflective spinner. The reflective devices may be of a shape or size to optimize the reflection of light and increase awareness of the sign's existence.

As shown in FIG. 1, eight illumination devices 14 are equally spaced radially around the base 12. The number, arrangement, color, and intensity of the illumination devices 14 will depend upon the intended location and environment in which the system will be installed. The illumination devices 14 may be light emitting diodes (LEDs), incandescent bulbs, or other devices that are energy efficient, have a long life span, and are highly visible in sunlight and low visibility conditions.

Alternatively, the base 12 can be formed to include a housing for an array of LEDs or other illumination devices 14 that cooperate to present a display in various patterns, various colors, or a combination of colors and patterns. The array can also be controlled to present one or more words in static or flashing format, or to present the words in a scrolling fashion to communicate a message to the reader regarding a dangerous situation, a preferred evacuation route, or other response as directed by a controlling entity, such as a governmental agency.

The illumination devices 14 are attached to the base 12 through holes drilled into the base 12, which avoids having to drill holes in the sign panel 20. As referenced above, the illumination devices 14 and the circuitry can be housed within the base 12. For example, all electronics would be securely enclosed or sandwiched between two layers of the base 12 and potted (epoxied). The illumination devices 14 can be a single device, a plurality of discrete devices arranged in various patterns around the base 12, or a single panel of an array of illumination devices 14 formed as part of the base where patterns, words, or symbols can be selectively displayed, as either flashing, static, or moving across the display.

The illumination devices 14 couple to a controller 24 mounted to the back side 21 of the sign 20 as seen in FIGS. 2 and 3. Alternatively, the controller 24 can be attached to the sign 20, to the post 22, or to the base 12. In one embodiment, the controller 24 includes a microprocessor and is coupled to the power source 18 and the illumination devices 14.

In one embodiment, illumination devices 14 are LEDs which are affixed to the base 12 and project through openings in the base 12. The LEDs are coupled to a printed circuit board housed within the base 12 and coupled to the controller 24. The controller 24 may be programmed to turn the illumination devices 14 on and off in any suitable pattern. Additionally, a plurality of lights, such as used to create a moving display, can be incorporated into a pre-made board attached to the base 12 with adhesive pop rivets or other fasteners, such as those listed above. The plurality of lights, may affixed to the base 12 in addition to the illumination devices 14.

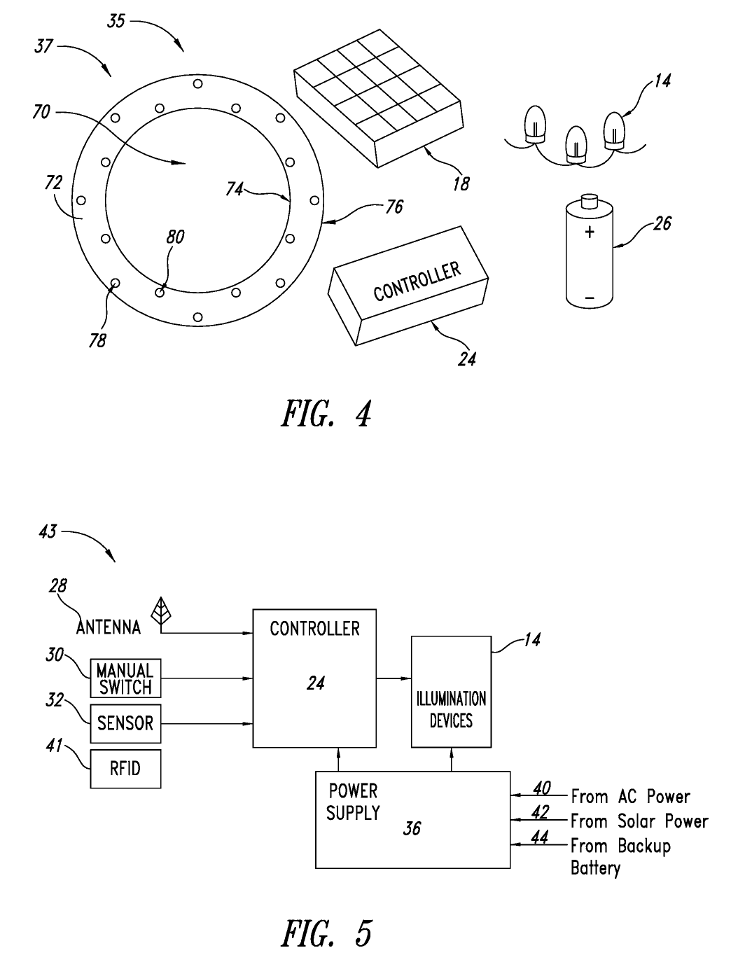

FIG. 4 illustrates an embodiment of the separate components of a kit 35, which includes a base 37, the power source 18, illumination devices 14, the controller 24, and a back up battery 26. The kit components 35 are attachable to existing or new signage and provide a means to bring attention to the sign, especially in low visibility or dangerous conditions. The back up battery 26 may provide supplemental power if the main power supply 18 fails or is obstructed. In designs where the power source 18 is the solar panel, the back up battery 26 can be used to store excess converted solar energy. Additionally, the back up battery 26 can power the system in low light conditions, such as during a storm, an overcast day, or after sunset.

The base 37 is formed as a ring 72 having a large opening 70 through the center of the ring and first and second pluralities of small holes 78 and 80 formed through the ring 72. The ring 72 also has an inner edge 74 and outer edge 76, the first plurality of holes 78 are formed adjacent to the outer edge 76 while the second plurality of holes 80 are formed adjacent to the inner edge 74. The smaller holes 78 and 80 are sized and shaped to receive and securely house illumination devices 14. In one embodiment, two sets of illumination devices 14 are coupled to the ring 72. One set of illumination devices 14 attach to the ring 72 through the first plurality of holes 78. The other set of illumination devices 14 attach to the ring 72 through the second plurality of holes 80. In such an arrangement, the two sets of illumination devices may be alternately toggled on and off or in a particular pattern.

Preferably, the illumination devices 14 are coupled together by a harness, which may be any type of conductive connector, such as copper. Also preferably, the illumination devices 14 are connected in parallel to maintain illumination if one lamp burns out, is damaged, or otherwise fails.

The block diagram of FIG. 5 illustrates an entire system 43 that includes the interconnection of the various electronic components of the kit 35, which includes a remote activation device 41, such as a radio frequency identification (RFID) interrogator. The controller 24 shown here is adapted to receive an input, such as an activation and deactivation signal from an antenna 28, a control signal through a manual switch 30, or the output of a sensor 32, to activate and deactivate the illumination devices 14. The controller 24 can be configured to operate the illumination devices 14 in a variety of patterns, colors, and intensities. For example, the illuminations devices 14 can be constantly on or flash intermittently, and neighboring illumination devices can alternate between on and off. Alternatively, the controller 24 can be configured to display words, symbols, or a pattern, either flashing, static, or moving on a panel.

The antenna 28 is adapted to receive a radio frequency communication signal from the remote activation device 41, such as a signal from the Emergency Broadcast System or other governmental or regulatory agency, e.g., RFID, VHF radio (tone paging), cell activation, and pager activation. For example, in the case of a volcanic eruption, the Emergency Broadcast System activates sirens or other warning means to notify the public. An evacuation route sign retrofitted with kit 35 would be adapted to receive such communication and subsequently activate the alerting system, such as the illumination devices 14 or other electro-mechanical means or a combination of both. Thereafter, the sign will be more visible to persons evacuating from the affected area.

The controllers 24 of various signs may be linked and controlled remotely to facilitate the selective activation of the alerting system. In order to provide security and prevent outside radio interference, a special frequency code, VHF tone generation, or a specific paging group, can be utilized. The remote device 41 may be at a fixed permanent location or a portable activation unit. Advantageously, the remote device 14 may be a portable unit for activation of a particular sign or signs by a local operator. For example, a Ranger needing to alert campers of an evacuation route from a campground threatened by an approaching fire could activate necessary evacuation route signs as he passed on foot, in a vehicle, or on horseback. The portable remote device 41 may be transported in a Ranger's vehicle, such as a car or truck, in a helicopter, in a saddlebag on a horse or mule, or in a backpack. The portable remote device 41 allows for more individual control over one or a select few signs retrofitted with kits 35 at a select time. The portable activation device 41 may also be used for locations too remote for normal activation means.

The controller 24 can also be configured to receive input from a sensor 32 configured to output a signal when triggered by an event. Upon receipt of the signal indicating the condition, the controller 24 activates the illumination devices 14 in a predetermined pattern. For example, signs warning of icy conditions can include a sensor adapted to output an activation signal when the temperature falls below freezing. The sensor 32 is intended to encompass, without limitation, the following types of conditions: ambient light level, wind speed, temperature, seismic activity, and the presence of ash, fog, ice, snow, or smoke in the air. In addition, the sensor can activate a warning of a potentially dangerous condition, such as fog, when the dew point-temperature spread is three degrees Fahrenheit or less.

A power supply 36 provides power to the controller 24 and the illumination devices 14. Power can be provided by a solar panel 42, which may be situated on the top of the post 22 facing the sun, as shown in FIG. 1. Alternate power sources may be utilized depending on the constraints of the particular installation environment, which include availability of AC power 40 from the electrical grid, wind power, or a battery 44. The back up battery 44 may also be included to support the system 43 in the event of a failure of the main power source.

FIG. 6 is an alternative block diagram of the electrical components of the kit 35. In this embodiment, power is supplied to the system from a solar panel 54 or a 110 volt power supply 52. The power supply 52, 54 couples to a rechargeable battery 56, which is coupled to a controller circuit 58. The rechargeable battery 56 may be a 12 Volt DC Gel Cell Battery or equivalent. The controller circuit 58 will control the activation and deactivation of the illumination devices 64 or other electromechanical devices attached to the sign panel. The controller 58 may include a 555 timing circuit or equivalent to control the system circuitry. The controller 58 will activate and deactivate the illumination devices in response to an output from a sensor 50. As illustrated in FIG. 6, the sensor 50 may a radio frequency trigger device that receives a remote signal. As reference above, the sensor may be configured to receive a signal from the Emergency Broadcast System in the event of an emergency. The control circuit 58 is coupled to two circuits 60 and 62 that control the illumination devices 64 attached to a base on an existing or new sign 64. As described above, the two circuits 60 and 62 may activate the illumination devices 64 in various patterns and sequences. In one embodiment, one set of illumination devices may be constantly activated while the second set of illumination devices is utilized only in emergency situations.

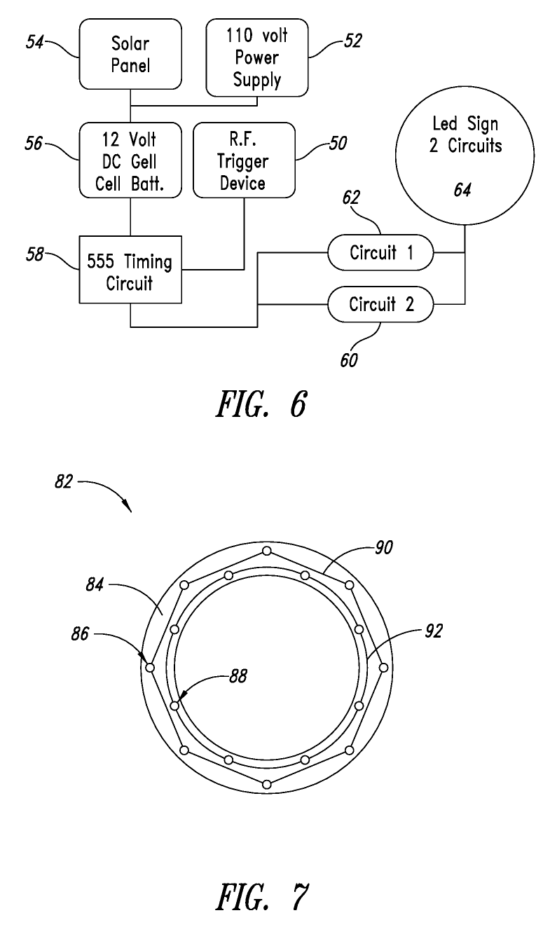

FIG. 7 illustrates the rear view of the base 82 with two sets of LEDs 86, 88 attached to the back face 84 of the base 82. Each individual lamp of the first set of LEDs 86 are coupled together by means of a conductive wire 90. The second set of LEDs 88 are coupled together by means of a different conductive wire 92. Preferably, the individual lamps of each set of LEDs 86, 88 are coupled in parallel to ensure illumination of remaining LEDs if one of the LEDs fails. The base 82 can be included as a component in the kit 35 as shown in FIG. 4, where two LED circuits are mounted to a ring shaped base. It is to be understood that other configurations of LED patterns may be used either exclusively or in combination, with a variety of ring shapes or partial ring shapes. It is to be understood that while LEDs are preferred and illustrated and described herein, other illumination devices may be used, including incandescent bulbs, halogen, fluorescent, and high pressure discharge.

Using the two circuits as shown in FIGS. 6 and 7 provides many possible configurations of lighting effects. For example, (1) all off—no power to both circuits, (2) all on—power to both circuits, (3) all flash—cycle power on and off to both circuits at the same time, (4) alternate flash (chase effect or scrolling)—alternate power to circuit 1 and circuit 2, and (5) half on constant—power on to circuit 1 and off to circuit 2.

The addition of a second RF trigger in the embodiment of FIG. 7 provides for remote de-activation. A time-out device (second timing circuit) can be utilized to allow for the device to reset from the emergency mode to the normal mode at the end of a preset period of time. This could be added, for example, in the 555 timing circuit.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

From the foregoing it will be appreciated that, although specific embodiments of the invention have been described herein for purposes of illustration, various modifications may be made without deviating from the scope of the invention. Accordingly, the invention is not limited except as by the appended claims and the equivalent's thereof.

1. A kit for enhancing visibility of a sign, comprising:
a base configured to be attached to the sign;
a plurality of illumination devices coupled to the base;
a power source; and
a controller coupled to the illumination devices and the power source.

2. The kit of claim 1 wherein the illumination devices include at least one light emitting diode (LED).

3. The kit of claim 1, further comprising: a housing for protecting the illumination devices, the power source, and the controller from damage.

4. The kit of claim 1 wherein the controller is adapted to deactivate and activate the illumination devices in response to at least one from among radio frequency communication, output from a sensor, and manual activation of a switch.

5. The kit of claim 1 wherein the controller is adapted to output a plurality patterns for activating and deactivating the illumination devices.

6. A sign, comprising:
a support;
a panel affixed to the support;
a base affixed to the panel;
a plurality of illumination devices coupled to the base;
a power source; and
a controller coupled to the illumination devices and the power source.

7. The sign of claim 6 wherein the illumination devices include at least one light emitting diode.

8. The sign of claim 6, further comprising a housing for protecting the illumination devices, the power source, and the controller from damage.

9. The sign of claim 6 wherein the controller is adapted to receive a signal indicating the occurrence of a condition.

10. The sign of claim 9 wherein the controller is adapted to deactivate and activate the illumination devices in response to the signal indicating a condition.

11. The sign of claim 6 wherein the controller is adapted to activate and deactivate the illumination devices in accordance with at least one pattern.

12. A system for increasing awareness and enhancing visibility of signage, comprising:
an attachment adapted to mount on existing signage;
a power circuit configured to provide power to the system;
a sensor coupled to the power circuit and configured to detect the occurrence of a condition; and
a control circuit coupled to the power circuit and the sensor and configured to communicate a visual indication of the condition.

13. The system of claim 12 wherein the sensor is adapted to receive a signal.

14. The system of claim 12 wherein the control circuit is adapted to activate and deactivate a plurality of illumination devices in response to an output from the sensor.

15. The system of claim 12, further comprising: a housing adapted to protect the power circuit, sensor, and control circuit.

16. An enhancement for signs, comprising:
a base adapted for attachment to a sign; and
a means for alerting associated with the base, the alerting means continuously providing a visual alert to the presence of the sign.

17. The enhancement of claim 16 wherein the alerting means comprises one from among reflective material, iridescent pigment, fluorescent material, phosphorescent materials, and photoluminescent material.

18. The enhancement of claim 16 wherein the alerting means comprises one from among flags, spinners, and wind socks.
